(19) United States
(12) Patent Application Publication
(10) Pub. No.: US 2020/0253026 A1
(43) Pub. Date: Aug. 6, 2020

(54) SYSTEMS AND METHODS FOR CREATING AN IDENTIFICATION SIGNAL

(71) Applicant: Daniel Allan, Celina, TX (US)

(72) Inventor: Daniel Allan, Celina, TX (US)

(21) Appl. No.: 16/666,942

(22) Filed: Oct. 29, 2019

Related U.S. Application Data
(60) Provisional application No. 62/801,089, filed on Feb. 4, 2019.

(51) Int. Cl. H05B 47/19; H04W 4/029; G06F 21/31

(52) U.S. Cl. CPC H05B 47/19; G06F 21/31; H04W 4/029

(57) ABSTRACT

Systems and method of producing a visual signal. More specifically, systems and methods of producing a visual signal for verification purposes. Other embodiments are also disclosed herein.

### CROSS-REFERENT TO RELATED APPLICATIONS

This application claims the benefit of U.S. Provisional Application No. 62/801,089, filed Feb. 4, 2019 and entitled Systems and Methods for Protecting Occupants from an Attack, which is incorporated herein by reference.

### FIELD OF THE INVENTION

This disclosure relates in general to the to the creation of signals, particularly the creation of a visual signal for identification purposes.

### BACKGROUND

In emergency situations, such as when paramedics, fire fighters, or police officers have been called to a location, every second matters. The faster that emergency personnel can get to the proper location, the probability of a positive outcome increases. One way to reduce the time for emergency personnel to reach the proper location is to have a visual signal verifying the location.

In addition, business is conducted often over the computer or phone. As such, two people need to meet without having spoke or met previously. This can lead to unsafe situations in which people aren't certain that they are meeting with the right person. A visual signal verifying the identification of the other person can increase the safety of such situations.

### BRIEF DESCRIPTION OF THE DRAWINGS

FIG. 1 illustrates a block diagram of an example computing system implementing system for generating a signal in accordance with some embodiments.

FIG. 2 is a block diagram illustrating an example of a method for generating a signal in accordance with some embodiments.

FIG. 3 illustrates an example of a design of a signal displayed on a smart phone in accordance with some embodiments.

FIG. 4 illustrates an example of a signal on a structure in accordance with some embodiments.

FIG. 5 is an example of a diagram illustrating the application of a location dependent signal.

FIG. 6 is a block diagram of an exemplary processor in accordance with one embodiment.

FIG. 7 is a block diagram of an exemplary computing system in accordance with one embodiment.

Like reference numbers and designations in the various drawings indicate like elements.

### DETAILED DESCRIPTION

The verification of identities can be a key component to improving safety in many situations. One example is the verification of a location's identity. For example, a visual signal that verifies the proper location for emergency personnel during a 911 call can reduce the time for the emergency responders to reach those needing the help.

Systems and methods disclosed herein can comprise the use of a light bulb or similar visual signal in combination with an application for use on a computer device, such as, for example, a smart phone, tablet, or computer. In one example, the app can be for iOS and Android devices. It should be noted that the light bulb used in the location bulb can comprise elements other than a traditional light bulb. For example, the location bulb can comprise light fixtures, light bulbs, security system lights, doorbells that light up (such as, for example, a smart doorbell), a security light, strobe light, etc. In some examples, the bulb can be considered any internet of things (IOT) device, initiated through an API and/or an SDK software development kit that leverages or is separate from a manufactures app that has the ability to light up. The bulb of the location bulb can comprise any item that can light up, whether now know or hereafter developed.

The systems and methods of the location bulb allow the use of a bulb to indicate where the user is, especially in situations where there is an emergency, such as, for example, a call to 911. As an example, when 911 is dialed on a cell phone with the app installed, it can send a signal to a bulb that will flash. The activated light can be placed in a conspicuous location either in an interior or exterior placement on a building that will enable a first responder to quickly locate a building or area of a building that a person has dialed 911 and is seeking help. In some instances, an interior location of a building can be identified with a bulb or bulbs (a strobe light, for example) that are activated in the area of the building in which the emergency has occurred. As examples, the locator bulb may be used in a school building setting, office building, or warehouse. It may also be suitably designed to work in a residential setting. Furthermore, in lockdown situations, the activated lights can not only be used to signify where the emergency is, but also as a signal to the occupants whether danger still exists. For example, one color can be used to indicate a dangerous situation requiring the occupants to shelter in place. Another color can be used to indicate that there is an all clear.

The location bulb can be configured to enhance the ability of first responders to locate a home or business in which someone associated with this building has dialed 911 and requires assistance. The light can flash with a defined flash pattern and brightness. Such a visual indicator can help the first responder find the exact location in which an emergency is occurring.

In other examples, the location bulb may also be used by any delivery service. As an example, the location bulb can flash or pulse with a pre-defined, vendor specific flash pattern and/or color pattern, to assist the delivery person locate the delivery destination. The use of this bulb can be linked via an API to an app that is utilized by individual vendors.

In some examples, if a customer does not have a location bulb, he or she may have the option of using the cell phone as the bulb and the screen (or camera flash) will begin to flash and the customer would either place their phone against a window or door that is visible to the delivery arrival area. In some examples, a special window cradle can be used to hold the phone in order to make the flashing visible to the delivery arrival area.

In addition, the verification of a person's identity can lead to safer business transactions. Often business is conducted over an app on our phones, and a consumer has no way to verify that the person they are supposed to meet with is the proper individual. Thus, there is an inherent safety risk when ordering such services. Therefore, example methods and systems herein allow personal signals with distinct designs to be created on a smart phone or similar device, enabling people to verify identities.

In each of the examples, the visual signal can be activated when a third party, such as, for example, a delivery driver is within a predefined distance (such as, for example, a ¼ mile). The app can also notify the customer that the delivery is getting close. Once the delivery has been made, the light can automatically deactivate.

The API can also be designed to work with home automation systems, such as, for example, Alexa, Google Home, Apple HomeKit, and other internet connected devices to provide audio notifications of the different delivery stages and activate the location bulb. In addition, systems and methods herein can be incorporated into any preexisting home monitoring or alarm devices.

The software can also be configured to notify the user that the battery is low and needs charging when required. The software can be configured to provide a unique, dynamic code that once used, is replaced with a new and unique code, to prevent hacking.

If a customer has made an order and plans on picking up food, the software may be utilized by a food service company to notify the customer, when the best time to leave and pick up food, so that it at its freshest point, considering the person's relative location in relation to the pickup point.

The software may also be modified and designed to be used by any business (i.e./ a doctor's office) to notify customers that their appointment will run late or early. It will give them the option to re-schedule or move to an earlier or later time or keep the current scheduled time.

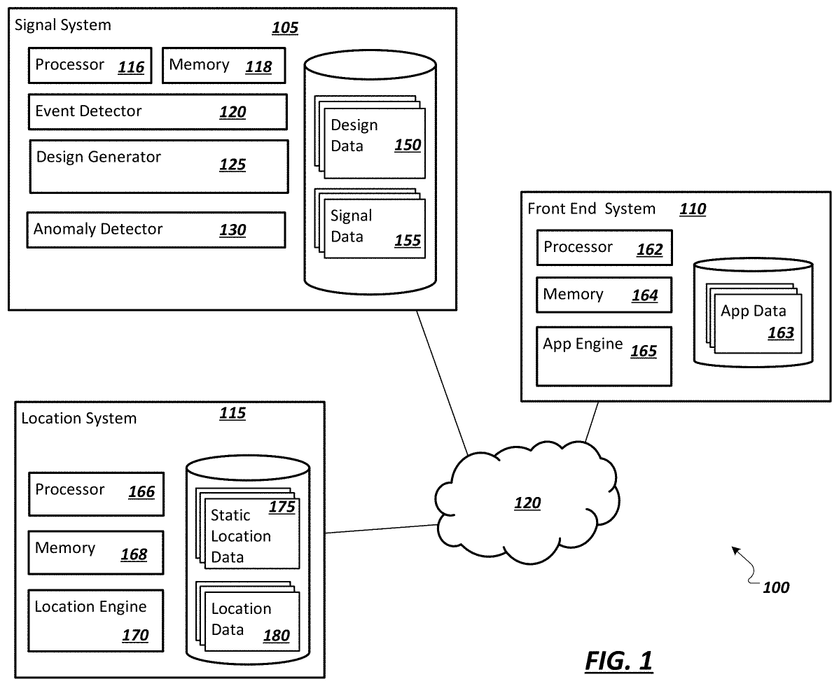

Turning to FIG. 1, a simplified block diagram 100 is shown illustrating an example system 105, such as a signal generation system, which may enable the deployment of a signal used for verification purposes. In some examples, the signal used for verification purposes may be a visual signal. Although the signal generated and deployed may be used for verification purposes, the signal may be used for other reasons not mentioned herein. A signal system 105 may utilize data (e.g., 163) generated by one or more front-end systems (e.g., 110), such as, for example, event data, which may comprise data related to an event that can trigger a signal, in addition to the design data (e.g., 150) related to the visual (or perhaps audio) design of the signal, and signal data (e.g., 155) related to all of the other data pertaining to the signal. The signal generation system 105 may be utilized, in some implementations, to design a signal, detect an event, and send instructions to execute the signal. In addition, the signal generation system can be used in cooperation with other systems, such as, for example, a location system (e.g., 515) that may be used to determine when the signal should be executed.

In one example, a signal generation system 105 may be implemented using one or more data processing devices (e.g., 116), one or more machine-readable memory elements (e.g., 118), among other components implemented in hardware and/or software to realize computer-implemented logic of the signal generation system 105. For instance, an event detector 120 may be implemented to determine if one or more events have occurred, which would render a signal necessary. The event detector 120 can use signal data 155, which may include data obtained from front-end system 110, including, for example, data related to the rules of an event.

As an example, the design generator 125 may be implemented to produce the physical design of the signal to be generated. For instance, design generator 125 may be implemented to design a particular signal that will appear on a smart phone or device. In other instances, design generator 125 may be implemented if the signal is to be displayed on a display device, such as, for example, an LED screen or the like. In yet other instances, the design generator 125 may be implemented to design a pattern of flashing lights on a lightbulb, or that a particular color be displayed on that light bulb. As an example, the design generator 125 may use design data 150 to create a design for the signal. Design data 150 may include all of the rules and possibilities of the signal design. In some instances, the design generator 125 may use one or more algorithms to create a random design of pixels, such as, for example, a 5 by 5 design of pixels.

The signal execution system 130 may be implemented to send instructions to activate the signal. In some instances, the instructions are sent to the device in which the front-end system 110 is hosted, such as, for example, a smart device. The device will then display the signal. In other instances, the instructions can be sent to a smart bulb or similar device. In yet other examples, the instructions are sent to a display device, such as, for example, an LED screen or similar devices. The instructions from the signal execution system can be sent to any device capable of displaying a visual signal.

As further shown in the example of FIG. 1, a signal generation system 105, in some embodiments, may interface with other systems, such as one or more front-end systems (e.g., 110) and location systems (e.g., 115). In some implementations, one or more of such systems may be implemented on distinct physical computing systems, which may be interconnected by one or more wired or wireless networks (e.g., 120). In one example, a front-end system 110 may be implemented using one or more data processing devices (e.g., 162), one or more machine-readable memory elements (e.g., 164), among other components implemented in hardware and/or software to realize computer-implemented logic of the front-end system 110. A front-end system 110 may therefore include an app engine 165 adapted to the operation of an application on the front-end system, which may be implemented using corresponding machine-executable code stored in memory (e.g., 164) and executed by one or more data processors (e.g., 162). Corresponding app data 163 may be generated from the operation of the app. In some instances, the app data 163 may include rules for the events and options for the signal design.

Data returned by the signal generation system 505 representing the design of the signal to be displayed, or instructions to display the signal, may be generated, and in some cases, compiled to be used as inputs to other systems involved in the display of the signal. For instance, an example location system (e.g., 115) may include a location engine (e.g., 170), which may be implemented using corresponding machine-executable code stored in memory (e.g., 168) and executed by one or more data processors (e.g., 166). A location system 115 may utilize location data 180 defining a location of a third party. Location data 580 may represent the current location of a third party, such as, for example, a delivery person, ride share driver, emergency personnel, and the like. Likewise, static location data 175 may comprise the location of the display device of the signal. In some examples, this may include a smart bulb, a display device, or a smart device, such as, for example, a smart phone. Location engine 170 can use the static location data 175 and location data 180 to help determine whether the signal needs to be displayed. As such, the signal generation system may use the data generated from the location system 115 to help determine whether the signal needs to be displayed.

In some implementations, the systems discussed herein (e.g., 105, 110, 115) may be implemented as a computer device, such as a personal computing device, mobile computing device, server computing system (e.g., a rack scale, blade server, or other server computer), a computing system implemented on a tool or other manufacturing machine, among other examples. The system 505 may run an operating system such as Windows, Linux, iOS, Symbian OS, Unix, Android, among other examples. Through such an operating system (or virtual machines or software containers implemented on the system), the system may have the capability to run applications locally and/or communicate with applications that are provided by remote servers in a communications network. Such systems may be implemented in a variety of form factors and embodiments.

Example systems, as illustrated in FIG. 1, may further include one or multiple computer-accessible memory elements. For instance, memory elements may be implemented as non-transitory computer readable media, such as flash memory, a magnetic disk drive, an optical drive, a programmable read-only memory (PROM), a read-only memory (ROM), or any other physical memory device or combination of such memory elements. Logic implemented in software can run on a processor capable of executing computer instructions or computer code. The processor might also be implemented in hardware using an application specific integrated circuit (ASIC), programmable logic array (PLA), field programmable gate array (FPGA), or any other integrated circuit. In some embodiments, a system may include or be implemented as a system on chip (SOC). In other embodiments, one or more blocks in a parallel processing device can be implemented as a separate chip, and the parallel processing device can be packaged in a system in package (SIP). In some embodiments, at least some logic and functionality of a machine (e.g., signal generation system 105) may be implemented using one or more hardware accelerator device implementing specialized functionality for use in performing various operations used by the system (e.g., by design generator 125), among other example implementations.

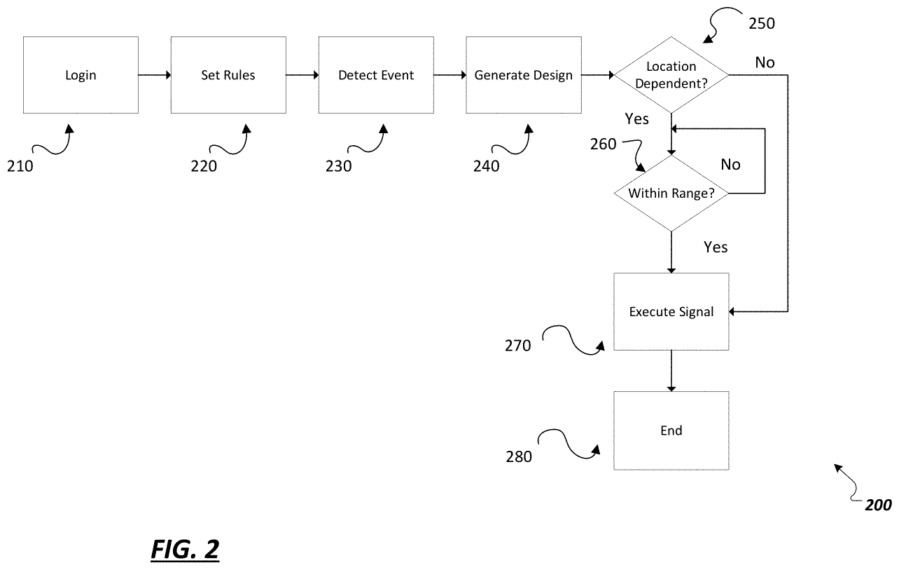

Turning to the simplified block diagram 200 of FIG. 2, an example flow is shown for a method for displaying and identifying signal. As illustrated, a user or organization logins 210 to a front-end system. As an example, the front-end system can comprise an app designed to operate a visual signal. In other instances, the front-end system can comprise an app designed for another purpose. As examples, the front-end system can comprise an alarm/911 system, delivery app (food, parcel, etc.), ride sharing and other taxi like apps, dating app, child care pick up app, elderly pick up app, an app for arranging a meeting between two parties, home services use, delivery on foot, real estate agents meeting for the first time, etc. In addition to the alarm services, the signal is ideal for one or more persons confirming their identity to one another. The method of diagram 200 can comprise a procedure 220 of setting rules for an event, a procedure 230 of detecting an event, and a procedure 240 of generating a design of the signal. If the rules of the signal are not location dependent as determined at 250 of diagram 200, the method can continue with a procedure 270 of executing the signal. If the rules of the signal are location dependent, it needs to be determined whether a party is within range to set off the signal. If the party is within range, the method of diagram 200 continues with procedure 270 of executing the signal. If the party is not within range, no signal is executed, and a determination is once again made at 260. After the signal is executed, the method of diagram 200 ends at 280. In some instances, it should be noted that more than one signal can be generated.

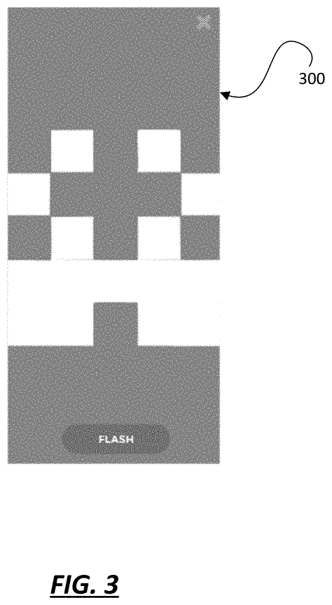

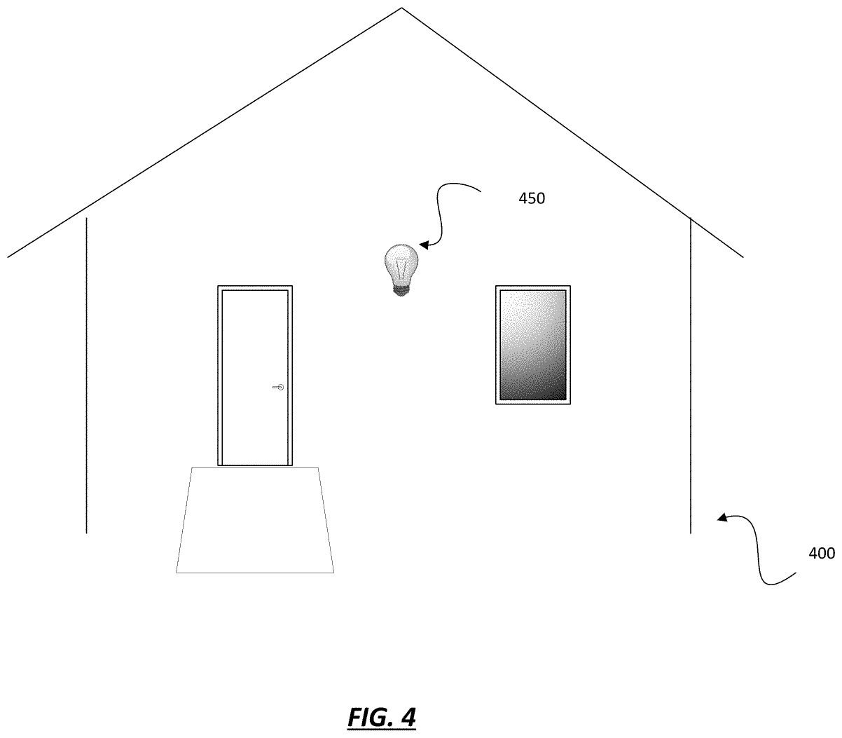

As illustrated in FIG. 2, a signal is generated, such as, for example, to confirm one or more identities. In some instances, the identities that are confirmed in the method of FIG. 2, may be one or more individuals. In other instances, the identity that is confirmed may be a structure, such as, for example, a residence or commercial building. Examples of a signal generated via the method of FIG. 2 can comprise a light bulb (e.g., FIG. 4), a customizable design on a smart device, such as a smart phone (e.g., FIG. 3), or some other display device.

With continued reference to the flow diagram of FIG. 2, the procedures of method 200, which may comprise procedure 220 of setting rules, procedure 230 of detecting an event, procedure 240 of generating a design of a signal, determining whether the signal is location dependent 250, if so, determining whether the range requirements are met 260, and procedure 270 of executing the signal, may be completed using a machine or machines, such as, for example, the exemplary system of FIG. 1.

Procedure 220 of the method of FIG. 2 comprises setting the rules for the signal activation. In some instances, the rules can be created by a user of the signal activation system. In other instances, the rules can be created by set be the system or a third party. As an example, if the activation signal is being used for an identification of a building during an alarm activation, the rules may be set by the alarm monitoring company, or even by emergency personnel in the location of the signaling system. In yet other instances, the rules can be set by any combination of the user, system, and/or third party.

Setting the rules in procedure 220 can comprise defining any or all of the pertinent details pertaining to the signal. Examples of the rules can include, for example, what event will set off the signal, whether signal activation is dependent on location, rules pertaining to the design of the signal, whether there is more than one signal, the participants who may be carrying a signal, and the like.

As an example, the event that will activate a signal needs to be defined. The signal may be activated to validate an identity. Therefore, an event will indicate that an identity needs to be validated. In one instance, a structural identity may need to be validated. For example, if there is an emergency (e.g., a burglar, fire, medical alarm, etc. has been activated), a signal can be activated to signify emergency personnel of the structure in which the emergency is located. Similarly, there are instances where a delivery is being made to a house or other structure. Once the delivery is being made, a signal may be activated to alert the delivery person of the proper structure.

In other examples, the identity that needs to be verified is a human identity. In such instances, an event can be created that will create a personal signal that an individual can display on his or her smart phone or similar device. Such a signal may be used to validate that identity of the individual holding the phone. In some instances, more than one person may show the same signal so that each person's identify can be verified. Examples of situations in which a person's identity can be verified includes: ride sharing and other transportation services, food delivery, dating apps, situations in which a child or senior citizen (or anyone else) is to be picked up, two people meeting to make a transaction, service providers coming to a residence or other structure, parcel delivery, and meeting someone for the first time, such as a real estate agent meeting a client for the first time.

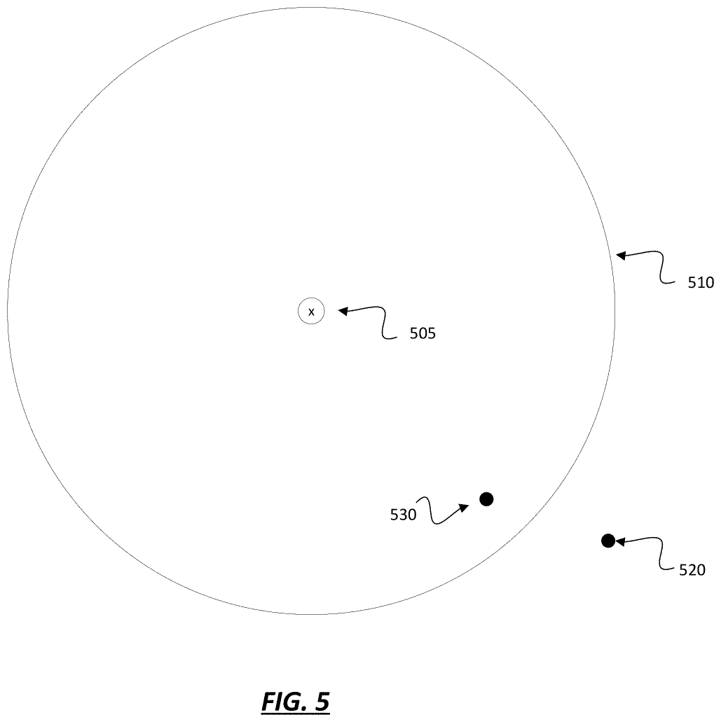

Another common rule that may need to be set is whether the signal is dependent upon location. As an example, it may be desirable to delay the signal after an event until a person gets closer to the location of the signal. For example, if an alarm is activated and emergency personnel are summoned, the signal can be delayed until emergency personnel get within a certain distance from the signal location. As another example, if a user orders delivery of some type, a signal may not be activated until the delivery driver gets within a certain distance of the signal. In addition, a rule can be defined that sets the distance radius for signal activation (e.g., FIG. 5.) As another example, instead of a distance setting, a geofence may be used to determine whether the third party is within range.

In addition, the design options of the signal may need to be set within the rules. For example, if the signal is to be displayed on a smart phone, it is possible to design a specific pattern that can be displayed (e.g., FIG. 3.) If the signal is a light bulb, perhaps a flashing pattern or color of bulb can be set within the rules.

Furthermore, it is possible that there is a desire to have more than one signal. For instance, if a customer orders a ride share service, it may be desirable for two signals to be generated—one for the customer and one for the driver. It may also be desirable for these signals to match, indicating that the customer and the driver are matched up.

The method of FIG. 2 continues with procedure 230 of detecting an event. As previously discussed, the event is defined in the rules. After the rule is defined, the system waits until the event is detected to activate the signal. For example, if the event is a call to 911, once a call is placed, the event is detected, and a signal can be generated. In another example, the even can be requesting a ride through a ride share company. Once the ride is requested, the event is detected, and a signal can be generated.

Procedure 240 comprises generating a design for the signal. The design for the signal can be as simple as a light bulb being constantly on. FIG. 4 illustrates an example of signal 450 on the outside of a house 400. Once a signal is activated, the light bulb can turn on and constantly stay on. As an example of another design, the light bulb can be a smart bulb capable of changing colors. As such, the design can comprise choosing a color. In one instance, the design of the signal can include the light bulb displaying a different color depending on the event that is detected. For example, an emergency alarm may produce a red light as a signal, whereas a delivery may produce a yellow light as the signal. Furthermore, the design of the signal can include flashing elements.

FIG. 3 illustrates another example of a potential signal design. As seen in FIG. 3, design 300 shows a pixelated image. The design of 300 comprises 5 pixels by 5 pixels. The pixels can be either white or another color. In one example, the design of the pixels can be randomly generated. In another example, one or more of the users can design the signal. Although the example of FIG. 3 shows a 5 by 5 pixel set in which the pixels are white or colored, any number of pixels and color combinations may be used. In addition, the signal of FIG. 3 can be flashing, changing, or any other design changes. In some examples, the user of the signal may be given the option to flash the signal, which may enable others, such as a ride share driver, to see the signal better.

In some instances, multiple different designed signals can be created. For example, different delivery companies can have distinct signals to signal their drivers the particular location for that driver's delivery.

With continued reference to FIG. 2, the method displayed in flow diagram 200 continues with a determination 250 of whether the signal activation is dependent on location. As demonstrated above, the location dependency of the signal can be established by the rules. If the signal is not dependent on any location status, then signal can be activated, as seen in procedure 270.

If the signal is location dependent, a determination 260 must be made whether an object is within range. As demonstrated above, the range can be defined in the rules established earlier. FIG. 5 illustrates an example implementation where signal activation is location dependent. In the example of FIG. 5, an event occurs at location 505. The distance may be set at any radius. For example, the radius can be set at 500 feet, 1000 feet, 0.5 miles, 1 mile, etc. 510 represents a circumference with the set radius as defined in the rules.

After the event is detected and it is determined that the signal activation is location dependent, the distance between the event occurrence and another object must be monitored. The other object can be something associated with the original event. For example, if the original event that is detected is an emergency alarm, then the other object can be an emergency vehicle. If the original event is a delivery, the other object can be the delivery vehicle. If the original event is a ride share request, the original location 505 can be the location of the smart phone of the user, and the other location can be the ride share vehicle.

For example, with continued reference to FIG. 5, after a ride is requested on a ride share app, a circumference of 510 with a radius of the distance set in the rules is established around the location 505 of the user requesting the ride. When the ride sharing vehicle is at location 520, which is outside of the distance established in the rules, no signal is activated. However, once the vehicle crosses circumference 510, such as location 530, for example, the ride share vehicle is within the established distance and the signal is activated via procedure 270. The signal can be activated via known communication methods, or those developed in the future. For example, a signal can be sent to the device that will display the signal via Bluetooth, Wi-Fi, ethernet, 4G, 5G, etc.

In the example of FIG. 5, the signal can be a design sent to the user's smart phone and the driver's smart phone. In addition, the signal sent to these phones can be identical, thus enabling the user and the drive to ensure that they have met encountered the right person.

Once the signal is executed, the method of FIG. 2 is complete and the user or users can deactivate the signal, either automatically or manually. As an example, a delivery driver may be able to manually turn off the signal on a house if he or she has located the housel. In other examples, the homeowner may desire to turn off the signal for his or her reasons.

Although the signal activation has been described with reference to FIG. 2, it should be noted that different embodiments still encompass that scope of the disclosures herein. For example, the procedures of FIG. 2 do not need to occur in the exact order listed in FIG. 2. As one example, the design can be generated 240 before any event is detected 230.

As another example, it is possible that the signal can be executed with a key fob or similar device. As an example, if the event is an emergency alarm, that alarm may have been activated by a key fob. Similarly, if the event is an emergency alarm, the signal may be automatically activated when a call is made to 911 or similar emergency services. In addition, the signal may be able to be activated remotely. For example, if a homeowner can see an intruder at the house remotely, then the signal (with an alarm potentially) can be activated. As another example, if a homeowner is not at home, but needs to signal to someone which house is his or hers, he or she can remotely activate the signal.

Furthermore, the example of FIG. 2 may comprise procedures not specifically mentioned herein. As an example, the method may comprise an additional procedure of sending out notifications. In such an example, a user can establish a list of contacts, such as, for example, neighbors and family, to be notified if the signal is activated. Once the signal is activated, notifications can go out to contacts (via SMS, cellular, or similar communication protocol) alerting the contacts that there may be an emergency. This would allow neighbors and close family to assist until emergency personnel arrive.

In addition, the systems and methods for generating a verification signal discussed herein can be used in conjunction with other systems and methods. For example, autonomous vehicles can use signals described herein to locate specific locations.

In addition, a package delivery location device can be used in conjunction with the signals identified herein. In addition, the package delivery location device (PDLD) can be used separately of the signals discussed herein. The PDLD can be designed to function as a package landing location for deliveries at a structure. The PDLD can be a weight sensitive device for the placement of packages. Packages can be delivered to the PDLD. The PDLD will sense the weight of the package. The PDLD can scan the package for the carrier or read the package via RFID or similar communications protocol. The PDLD can be used in conjunction with a home security or monitoring system, or the like. Therefore, the PDLD will be able to notify the homeowner or the business that a package or packages have been delivered. Likewise, the PDLD will sense when packages have been removed and the homeowner or business can be notified.

As mentioned, the PDLD can be used in conjunction with the identification signals discussed herein. For example, once a package is placed on the PDLD, the PDLD can notify the system to turn the signal off.

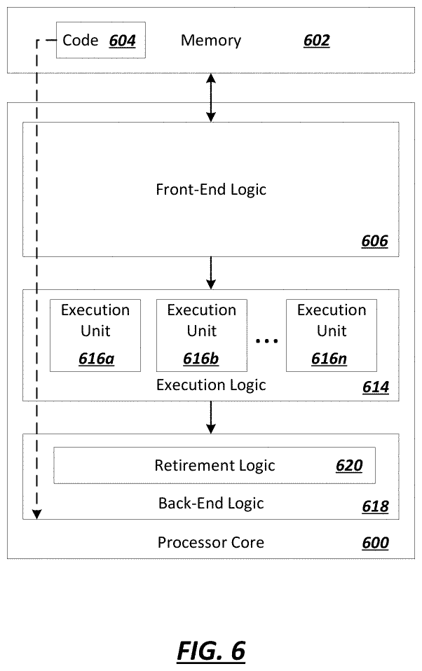

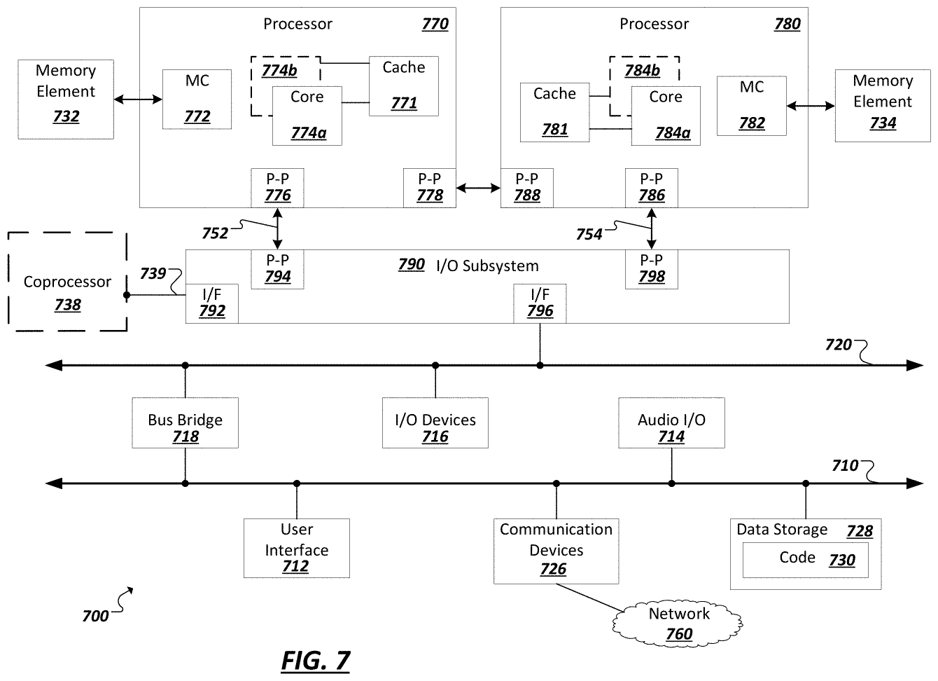

FIGS. 6-7 are block diagrams of exemplary computer architectures that may be used in accordance with embodiments disclosed herein. For instance, the computer architectures shown in these examples may be utilized to implement or execute an improved compiler and/or a portion of a target computing device. In other examples, the computer architectures shown in these examples may consume results generated by the neural network, provide data for use as inputs to the neural networks, among other cooperative uses. It should be appreciated that other computer architecture designs known in the art for processors and computing systems may also be used. Generally, suitable computer architectures for embodiments disclosed herein can include, but are not limited to, configurations illustrated in FIGS. 6-7.

FIG. 6 is an example illustration of a processor according to an embodiment. Processor 600 is an example of a type of hardware device that can be used in connection with the implementations above. Processor 600 may be any type of processor, such as a microprocessor, an embedded processor, a digital signal processor (DSP), a network processor, a multi-core processor, a single core processor, or other device to execute code. Although only one processor 600 is illustrated in FIG. 6, a processing element may alternatively include more than one of processor 600 illustrated in FIG. 6. Processor 600 may be a single-threaded core or, for at least one embodiment, the processor 600 may be multi-threaded in that it may include more than one hardware thread context (or “logical processor”) per core.

FIG. 6 also illustrates a memory 602 coupled to processor 600 in accordance with an embodiment. Memory 602 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 600 can execute any type of instructions associated with algorithms, processes, or operations detailed herein. Generally, processor 600 can transform an element or an article (e.g., data) from one state or thing to another state or thing.

Code 604, which may be one or more instructions to be executed by processor 600, may be stored in memory 602, or may be stored in software, hardware, firmware, or any suitable combination thereof, or in any other internal or external component, device, element, or object where appropriate and based on particular needs. In one example, processor 600 can follow a program sequence of instructions indicated by code 604. Each instruction enters a front-end logic 606 and is processed by one or more decoders 608. The decoder may generate, as its output, a micro operation such as a fixed width micro operation in a predefined format, or may generate other instructions, microinstructions, or control signals that reflect the original code instruction. Front-end logic 606 also includes register renaming logic 610 and scheduling logic 612, which generally allocate resources and queue the operation corresponding to the instruction for execution.

Processor 600 can also include execution logic 614 having a set of execution units 616a, 616b, 616n, etc. Some embodiments may include a number of execution units dedicated to specific functions or sets of functions. Other embodiments may include only one execution unit or one execution unit that can perform a particular function. Execution logic 614 performs the operations specified by code instructions.

After completion of execution of the operations specified by the code instructions, back-end logic 618 can retire the instructions of code 604. In one embodiment, processor 600 allows out of order execution but requires in order retirement of instructions. Retirement logic 620 may take a variety of known forms (e.g., re-order buffers or the like). In this manner, processor 600 is transformed during execution of code 604, at least in terms of the output generated by the decoder, hardware registers and tables utilized by register renaming logic 610, and any registers (not shown) modified by execution logic 614.

Although not shown in FIG. 6, a processing element may include other elements on a chip with processor 600. For example, a processing element may include memory control logic along with processor 600. The processing element may include I/O control logic and/or may include I/O control logic integrated with memory control logic. The processing element may also include one or more caches. In some embodiments, non-volatile memory (such as flash memory or fuses) may also be included on the chip with processor 600.

FIG. 7 illustrates a computing system 700 that is arranged in a point-to-point (PtP) configuration according to an embodiment. In particular, FIG. 7 shows a system where processors, memory, and input/output devices are interconnected by a number of point-to-point interfaces.

Processors 770 and 780 may also each include integrated memory controller logic (MC) 772 and 782 to communicate with memory elements 732 and 734. Example processors (e.g., 770, 780) may include one or more processor cores (e.g., 774a-b, 784a-b), which may be coupled to respective cache memory (e.g., 771, 781). In alternative embodiments, memory controller logic 772 and 782 may be discrete logic separate from processors 770 and 780. Memory elements 732 and/or 734 may store various data to be used by processors 770 and 780 in achieving operations and functionality outlined herein.

Processors 770 and 780 may be any type of processor, such as those discussed in connection with other figures. Processors 770 and 780 may exchange data via a point-to-point (PtP) interface 750 using point-to-point interface circuits 778 and 788, respectively. Processors 770 and 780 may each exchange data with a chipset 790 via individual point-to-point interfaces 752 and 754 using point-to-point interface circuits 776, 786, 794, and 798. Chipset 790 may also exchange data with a co-processor 738, such as a high-performance graphics circuit, machine learning accelerator, or other co-processor 738, via an interface 739, which could be a PtP interface circuit, such as, for example, point-to-point interface circuit 792. In alternative embodiments, any or all of the PtP links illustrated in FIG. 7 could be implemented as a multi-drop bus rather than a PtP link.

Chipset 790 may be in communication with a bus 720 via an interface circuit 796. Bus 720 may have one or more devices that communicate over it, such as a bus bridge 718 and I/O devices 716. Via a bus 710, bus bridge 718 may be in communication with other devices such as a user interface 712 (such as a keyboard, mouse, touchscreen, or other input devices), communication devices 726 (such as modems, network interface devices, or other types of communication devices that may communicate through a computer network 760), audio I/O devices 714, and/or a data storage device 728. Data storage device 728 may store code 730, which may be executed by processors 770 and/or 780. In alternative embodiments, any portions of the bus architectures could be implemented with one or more PtP links.

The computer system depicted in FIG. 7 is a schematic illustration of an embodiment of a computing system that may be utilized to implement various embodiments discussed herein. It will be appreciated that various components of the system depicted in FIG. 7 may be combined in a system-on-a-chip (SoC) architecture or in any other suitable configuration capable of achieving the functionality and features of examples and implementations provided herein.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although the invention has been described with reference to specific embodiments, it will be understood by those skilled in the art that various changes can be made without departing from the spirit or scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the resin product and the methods of creating the same discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. At least one machine-readable storage medium with instructions stored thereon, wherein the instructions are executable by a machine to cause the machine to:
create rules related to an identification signal;
detect an event;
generate a signal design; and
display the signal with the signal design.

2. The storage medium of claim 1, further comprising determining whether the signal is location dependent.

3. The storage medium of claim 2, wherein if the signal is location dependent, the displaying of the signal occurs when the location requirement is met.

4. The storage medium of claim 3, wherein the location requirement is a defined distance.

5. The storage medium of claim 3, wherein the location requirement is a geofence.

6. The storage medium of claim 1, wherein the signal comprises a light bulb.

7. The storage medium of claim 6, wherein the signal comprises a light bulb that is flashing

8. The storage medium of claim 1, wherein the signal comprises the signal design displayed on a portable device.

9. The storage medium of claim 8, wherein signal design comprises more than one pixel and more than one color.

10. The storage medium of claim 8, wherein the signal comprises the signal design displayed on multiple portable device.

11. The storage medium of claim 1, wherein the event comprises calling emergency services.

12. The storage medium of claim 1, wherein the event comprises at least two individuals meeting each other, and the signal is used to verify identities.

13. A method comprising:
receiving a set of rules, wherein the set of rules comprises one or more rules related to the display of a verification signal and wherein the set of rules defines at least one event;
detecting the at least one event;
generating a signal design;
determining whether the verification signal is location dependent;
determining whether the location dependency has been met; and
generating the verification signal once the location dependency has been met.

14. The method of claim 13, wherein the verification signal comprises activating a light bulb

15. The method of claim 13, wherein the verification signal comprises displaying the signal design on a display device.

16. The method of claim 15, wherein the verification signal comprises displaying the signal design on more than one display device.

17. A system comprising:
at least one data processor;
a memory; and
an event detector, executable by the data processor to determine whether an event has occurred;
a design generator, executable by the data processor to: create a signal to be displayed for verification purposes; and
signal execution system, executable by the data processor to execute the display of the signal.
